(19) United States
(12) Patent Application Publication
(10) Pub. No.: US 2012/0278145 A1
(43) Pub. Date: Nov. 1, 2012

(54) METHOD FOR PROVIDING ON-LINE SALE AND MANAGEMENT OF ADVERTISING SPACE ON SIGNS AND BILLBOARDS

(76) Inventors: Karim L. Boudah, Houston, TX (US); Michael L. Drake, Houston, TX (US); Eric Jeanson, Sugarland, TX (US)

(21) Appl. No.: 13/543,338

(22) Filed: Jul. 6, 2012

Related U.S. Application Data
(63) Continuation of application No. 11/881,589, filed on Jul. 27, 2007.

(51) Int. Cl. G06Q 30/02

(52) U.S. Cl. 705/14.4

(57) ABSTRACT

A method and system for supporting e-commerce transactions directed to placement of advertising on dynamic signs by creating dynamic e-commerce Web sites for permitting consumers to select and acquire time and space on selective signs, for managing the content of a consumer message and for collecting payment for the acquired time and space. The content may be provided by the consumer by uploading it to the Web sites or by the manager of the Web site. Space and time may be auctioned over the Web sites, allowing consumers to competitively bid for specific space and time blocks.

### CROSS REFERENCE TO RELATED APPLICATION

This application is a continuation of application Ser. No. 11/881,589, filed on Jul. 27, 2007 and claims priority under that application, said application being fully incorporated by reference herein.

### BACKGROUND OF THE INVENTION

1. Field of the Invention

This invention relates to methods and systems for supporting on-line commerce and is specifically directed to methods and systems for selling selective advertising time and space on signs and billboards.

2. Discussion of the Prior Art

Over the years, advertisers have attempted to focus their advertisements towards individuals who are most likely to be positively affected by the ads. On early Saturday mornings, for example, many television ads are often geared towards children who tend to watch the morning programs. On the other hand, during the late evening news, the ads are typically directed to a more mature audience.

A well-known advertising device is the conventional billboard, known as a “static” advertising device. Such devices are used along roadways, in airport terminals, at bus depots, on the sides of buses, in restaurant restrooms, etc. See, U.S. Pat. No. 5,947,592 to Barlow; U.S. Pat. No. 4,754,582 to Cameron; U.S. D317,790 to He; U.S. Pat. No. 5,150,116 to West; U.S. Pat. No. 5,543,856 to Rosser, et al.; U.S. Pat. No. 5,703,564 to Begum, et al.

These traditional advertising boards are static in that the advertising image is permanently or semi-permanently affixed to the boards. One drawback of such billboards is that in order to change the message, it is necessary to physically change the message by replacing the sign or repainting, repapering or otherwise physically changing the message.

More recently, dynamic billboards such as electronic billboards have been employed and are known in the art. Such devices allow the information to be displayed and changed electronically or otherwise. See, “Turning Pixels into Panache: NASDAQ's Sign on Times Sq. Fulfills a High-Tech Dream”, New York Times, page B1 and B10, Feb. 17, 2000. These devices allow for a variety of messages to be communicated by the device without the physical changes required by the earlier static billboards. This has also enabled the use of video and animation technologies to display the information. See also, U.S. Pat. No. 5,606,154 to Doigan et al. (Timed Advertising In Elevators and Other Shuttles); U.S. Pat. No. 5,969,704 to Green et al. (Configurable LED matrix display).

U.S. Pat. No. 5,214,793 to Conway et al. discloses an electronic and vehicle traffic control communication system which is intended to replace existing billboards. Information transfer is accomplished using short bursts of microwave pulses from independent transmitters placed in selected locations along roadways. The transmitted signals are coded prior to transmission and decoded after being received by receivers in the vehicles. After decoding the pulses, a receiver will retrieve complete messages from a data base included as part of the in-vehicle receiver system. At the selection of the driver, the messages can be displayed or replayed audible. The Conway patent also describes other systems for communicating traffic and commercial information to drivers.

U.S. Pat. No. 5,848,129 to Baker discloses a billboard system which produces, in addition to the visual message provided by an associated billboard, a related audio message that is transmitted to passing vehicles and which enables ready changing of the message to be transmitted, at all times of the day, by calling the change in over a telephone line from a remote location such as a business office or advertising agency.

U.S. Pat. No. 5,966,696 to Giraud relates to electronic billboards which include a sensor for determining when an individual is within the advertising range and a tracker to track consumer exposure to a number of different advertisements.

U.S. Pat. No. 6,484,148 to Boyd discloses electronic advertising devices and methods for providing targeted advertisements to one or more individuals bases on consumer profiles associated with signals generated by the targeted individuals.

U.S. Pat. No. 6,543,646 to Bar-Yona discloses a computerized method for creating a multi-page print for use with a dynamic display based on the relative periodic displacement of the print relative to a lenticular screen.

Of course, the purpose of an advertisement is to encourage a future transaction between an individual and the company sponsoring the ad. Such companies and their advertisers typically pay to have advertising messages displayed on such displays. The effectiveness of an advertisement is typically a result of a number of factors. The content and style of the ad is typically geared to attract an individual's attention and increase the likelihood the individual will react favorably to the ad (i.e., purchase the product and/or service being advertised). The effectiveness of the ad is also determined by which individuals and how many individuals are exposed to the ad. Currently, advertisers are faced with the difficult task of determining where to place ads to reach a certain targeted audience. An advertisement for a sale on golf clubs by an advertising store may be optimally located near a golf course to reach a high concentration of potentially interested golfers. Since the ad may be located outside a city, the cost of placing the ad may be less expensive then if it was placed at a busy intersection of a city. However, such an ad would only reach a small number of consumers (i.e., those that pass by that particular golf course). A greater number of individuals may be exposed to the ad if placed on a busy avenue such as Fifth Avenue in midtown New York City where thousands of consumers may pass a properly placed sidewalk ad on any given day. However, only a fraction of those passing individuals may be potential golf consumers. Therefore, the costs of placing the ad in such a location may not be justified since, although a large number of individuals will be exposed to the ad, the ad would be properly targeted to only a fraction of those who see it.

A significant drawback to such displays is that they treat all consumers the same. This is a severe limitation given virtually all consumer oriented industries are trending from market or segment-focused marketing and advertising toward consumer or individual-focused marketing and advertising. Thus, the effectiveness of previous advertising billboards and other advertising devices suffers due to the inability to display or otherwise convey messages which are targeted to one or more individuals within the range of the advertisement.

It would be desirable to provide an advertising system and method which selects and displays advertisements which are targeted to individual(s). It would be desirable to have the ability to change the advertisements at will, to target different demographic groups depending on time and location. For example, during rush hour a billboard on a highway might be effective for fuel or automobile advertisements. During evening hours it may be desirable for the same billboard to advertise a particular eating or entertainment establishment.

In addition to being able to target advertisements to specific demographics, it is also desirable to open the advertising industry to a larger number of advertisers. Static billboards are often rented monthly and are fairly expensive to use and maintain. Even electronic billboards, which are changeable, are generally operated in a manner requiring a substantial investment over an extended period of time. In view of the fact that such billboards may only reach a targeted demographic during a short span of a twenty-four hour day, there remains a need to make advertising more accessible and more efficient by maximizing the time and content of the advertisements as well as the location.

Parallel technologies have adapted the Internet to maximize exposure and increase efficiency of marketing efforts. Over the last decade on-line commerce has become widespread. Well-known examples of Web sites supporting such commerce are: Amazon, E-bay and Yahoo. These sites operate in two fundamental ways. First, it is possible for a consumer to find a product or services at a listed price and purchase the product on-line for that price. Second, products and services may be placed for auction on the site and consumers may bid on-line. Typically, an item will be placed for auction for a specific period of time and once the time has closed the highest bidder will win the auction. It is possible to place minimum bid floors on items, permitting the seller to establish the lowest successful bid he will accept for the product or service. The sites manage the transaction, including establishing criteria for making and accepting payments and for assuring that the products and services are delivered to the consumer.

These electronic enhancements to the auction process allow remote bidders and sellers to engage in auctions from the convenience of a remote workspace or even their homes. These enhancements have typically involved facilitating the auction process while keeping the same general foundation where a user offers a product for auction through a site manager that executes the auction and receives bids for the item. At the end of a specified period of time or when no further bids are received, the site manager closes the auction to further bidding and the highest bidder pays for and receives the item. While the seller and bidder may be represented by other parties, the ultimate control of the auction is performed in a centralized manner where the site manager runs the process.

The final sale price is ultimately dependent on the number of bidders for a product at that site and the visibility of that item among all the items being offered at that site.

U.S. Pat. No. 5,835,896 to Fisher discloses an automated system used for auctions on the Internet where the buyer submits bids to the system which validates the bids and ultimately notifies the successful bidder(s) when the auction is over.

U.S. Pat. No. 5,890,138 to Godin discloses another Internet based auction system where users access a central database of products to purchase items from a quantity of similar items. The timeframe of the offer is strictly controlled and a number of items are offered where the price decreases until all of the items are sold or until the timeframe of the sale expires. The system updates the displayed availability information at periodic intervals where the period is shortened as the sale comes to an end.

U.S. Pat. No. 5,905,975 to Ausubel discloses an auction system where user sellers may define bidding rules that are subsequently enforced throughout the bidding process for an item, thus allowing users to control the amount of time that they are required to devote to the bidding process. The user's system and the auctioneers system communicate automatically to determine how the bidding is incremented according to the rules defined.

U.S. Pat. No. 6,415,270 to Rackson discloses a multi-auction service system and method for replicating an item to be auctioned at a plurality of remote auction services, where the multi-auction service detects bids at the plurality of remote auction services for the item in order to replicate the optimal bid at each of the remote auction services such that the optimal bid is afforded to a bidder or seller.

U.S. Pat. No. 7,110,967 to Espenes discloses a method and system for enhancing e-commerce transactions by placing product marketing information in front of the targeted potential customers by analyzing the product, mapping it to one or more categories, creating dynamic e-commerce Web sites for the products, selecting appropriate e-commerce marketplaces based on previous placement results and client product objectives.

### SUMMARY OF THE INVENTION

The subject invention is directed to dynamic electronic signs having the flexibility of being changed at any time from a remote location. The invention is specifically directed to sign systems which permit an advertiser to select the time and location of his ad based on ad specific demographics, potentially maximizing his return on investment in the advertising scheme. In addition, by incorporating auction techniques for the time and space, the system permits the advertiser to obtain space at an optimum price.

The dynamic sign system of the invention is controlled electronically, typically from a remote location via a communication system such as the Internet, cellular telephone, land line telephone, satellite communication or private network. This permits maximum flexibility for each sign on the system. By way of example, but by no means limiting, space can be allocated on each sign by amount of area, time of display, content, and intensity. For example, a particular user may only want an advertisement displayed at a particular time of day, say weekdays during afternoon rush hour. Another advertiser might want to use the same space on weekends. In some cases, the advertiser may only want a portion of a sign and the remainder may be used for other purposes. Where a network of signs is available, the advertiser may want to schedule ads on a plurality of strategically located signs in the network. All of these decisions may be made from a central location and transmitted to each sign via the network. In addition, the advertiser can log into the central management site and confirm which signs are being utilized at what times and review the content which has been transmitted to each selected sign. This permits maximum flexibility of the advertiser's resources. It also maximizes return on the sign network operator by permitting it to maximize sign revenue by permitting multiple sales for each sign depending on optimum use by a plurality of advertisers.

The dynamic billboard of the present invention is connected to communication networks for providing display advertising in real time, scheduled time or present time, providing a unique combination of billboard technology and billboard advertising services.

The dynamic billboard of the subject invention typically is an electronic display such as, by way of example, a large LED (Light Emitting Diode) display or other changeable electronic media which may be mounted on a pole or other support for replacing the traditional static print billboards.

By combining the development of electronic billboard with the advertising service, the advertising system of the subject invention permits the design of ad hoc solutions to address the electronic outdoor advertising market and ensure excellence in service delivery. Specifically, an advertiser can not only select the location of his ad but also the times of day when it will be displayed. As an example, a billboard on a major highway may be used to advertise automobile sales during morning rush hour and used to advertise entertainment venues in the evening.

A key component of the invention is the service aspect for supporting the advertising industry. A network of dynamic signs in accordance with the subject invention provides the network operator with a flexible system for controlling space, time and content on each sign from a central management site. The scheduling may be managed on a time/space/location/content purchased basis, providing advertisers with maximum flexibility and with maximum return on their advertising dollar. Scheduling may be automatic through an e-commerce based application. The subject invention simplifies service for the advertising customer as well as the service providing the advertising by making available a fully automatic advertising service, where a customer can log in, select a time slot for advertising, place a bid for the service or meet the guaranteed price requirement and automatically schedule the advertisement. For the service provider there is no need to interact with the customer at all once their payment method and advertising content has been approved on the first use by the advertiser. This means that the schedule is set up and the billing process is handled through some means of an e-commerce transaction or automated billing process for customers with an established account.

The advertiser can purchase the space not only by location and square foot area but also by time blocks within specified period of time such as a specific time of day, or a twenty-four hour, daily, weekly, monthly, yearly or other selected period. In the preferred embodiment two pricing structures are utilized. A guaranteed price cap assures the advertiser of the time and location of his choice. However, in order to open the advertising space up to a larger number of users, the space is open for bid under an auction system, permitting any party to bid on available space for a specific period, with the high bidder winning.

The auction will be operated under e-auction technology and is open to any space and time slots of electronic billboards unless locked out by a guaranteed price purchaser. Advertisers will offer price for a time and advertising space and will compete among themselves to win the auction.

This assures wider availability of advertising space to a larger group of users. It also increases the likelihood that the space will be generating revenue during off-peak periods without requiring a major advertiser to purchase space at neither a time he wants nor needs. For example, drive-time rush hour may be considered a peak time for certain types of advertising. This may command a maximum price for space on signs visible from the flow of traffic. However, under prior art systems an advertiser may be unwilling to pay a high price to advertise in a specific location because the advertisement has very little useful traffic at other than this peak time. The system of the present invention permits the advertiser to purchase time only when desired. It also permits the system operator to charge a maximum price for this desired time. Just as importantly, other advertisers may be willing to use the same space for other advertising during off-peak times. This permits the system operator to generate revenue during this period as well, maximizing use of the sign system and thereby increasing sign system revenue. In a preferred form of the invention, the space and time will be open to auction permitting the highest bidder for a time and space allocation to advertise in accordance with his winning bid.

The system of the subject invention is useful not only for off-premise advertising, such as roadside billboards, but also for on premise advertising such as advertising by strip mall tenants. For example, a store in the mall may want to advertise a sale during a specific period of time. The mall management may control the system from a central location which can be remote from the mall, using a public or private communication network.

The electronic billboards of the subject invention may be mono-color or full color displays. The full color and mono-color message center solutions addresses the market of off-premise and on-premise commercial advertising and may display full color or mono-color texts, graphics, pictures, dynamic displays, video or animation which has been defined and scheduled using the management system of the present invention. Specifically, the message center receives data through either wireless or cable communication to control the image and text being displayed. This permits remote control and management of the display and provides for quick message setting and scheduling, low maintenance and service costs and, because of the LED format or other electronic media format, low energy consumption.

The full color version and mono-color version may each provide close pixel pitch format, medium pixel pitch format or large pixel pitch format within a large or small area display. The multi-color display is suitable for applications requiring color images. Either large or small pixel spacing can be suitable for extended distance viewing.

Pixel spacing can be chosen to optimize either cost or distance requirements. For lower cost or longer distance large or medium pixel spacing can be used. For close viewing or higher cost and hither resolution images small or medium pixel spacing can be used. The total number of pixels used in the display can also be selected to manage the cost of electricity in the advertising.

The market of the electronic billboards pertains to off-premise and on-premise advertising. The system provides electronic billboard advertising service for highways, roads, streets and other public venues such as malls, airports, and public spaces to maximize exposure to different groups of customers. Local businesses and large corporations can advertise their products and services, promote their names or advertise for hiring on the electronic billboards at times and locations which maximize their return on the advertising dollar. When used for on-premise advertising, the dynamic sign system may be used in multi-tenant facilities where there may be common signage for tenants or where the tenants have individual signage but where there may be a reason to have common advertising media for use by individual tenants according to a schedule or immediate needs basis.

The central management of the site permits maximum control over content, allows the system manage to automatically check content for quality, permits the advertiser to review content via the Internet or other communications network, and permits optimum control over location, space and time slots on the system.

TV channels, radio channels, movies companies, local event organizers (concerts, rodeo, sport and the like) and gaming companies can advertise their shows on electronic billboards at select times while permitting the primary advertisers access to the same space at other times. This is particularly useful, because it allows a promoter, for example, to advertise a single date event without having to pay for space which continues to advertise the event once it is over. The space can be immediately reassigned to other advertisers.

Local schools and universities also can promote their name and their specificities. Local religious groups can promote their faith on electronic billboards. Various, associations and clubs can communicate their activities to boost their membership base. This can all be accomplished on a minimum time/investment basis, greatly expanding the functionality of the billboard. For example, a church may buy space only on Friday evening through Sunday when a rush hour advertiser has Little desire to use the same space. Both parties can maximize their exposure and maintain control over their costs in this manner.

Sections of the sign can be separately managed so that certain sections of the message board may have different scheduling than other sections. This may add the capability of maintaining a company icon or logo or custom message that has more or less permanence than the other section or sections of the billboard, sign or message board. A sign may be separated into individual sections and offered as individual message areas individually as if they were each separate billboards, the content of which is each managed separately. The sections may be separated by a borderline of colored lights to show the separate areas or not. If the separate image is a logo or icon the image can have a custom selected background or have the background default to the color of other advertising on the display. Specifically, each section of the sign may be independently controlled as to time and content.

In addition, City, State, Federal authorities can send public notices or warning messages to inhabitants, perhaps even having the ability to preempt scheduled advertising during regional emergencies such as hurricanes and floods.

Provisions may be made for regularly scheduled public service messages for the purposes of civic issues or special municipal supported venues. This can apply to county, state, federal or other special purpose venues as well. The time for such public service blocks may be a regularly scheduled block of time such as some period every hour or every day or even every minute or few minutes. Public service and emergency service messages may have special provisions for payment for services including accounts which are billed in special manners. Advertising costs for public service messages may in some instances be reduced in price in exchange for tax credits as may be offered by the entity using the service, such as city, county, state or federal government or agencies.

In its preferred form, the invention comprises one or more strategically placed dynamic electronic billboards. The service chain starts with customers who log on to a dedicated Web site to access different services.

In order to optimize pricing for advertising space and time, customers will place auctions to book a group of electronic billboards or a specific electronic billboard or any portion of one or more billboards for a specific time or a plurality of time periods. Time is sliced according to the preferences of the system managers and may be any combination of time slots from seconds to years. The time slots may be different sizes in some instances so that at one time of day you may purchase a few seconds in slice or in another time of day you may purchase longer periods in a slice such as hours.

Auctions may be closed at a specific time, for example 24 hours, before the time of delivering the advertising to enable the space manager to check contents. Time deadlines may be established according the system manager's convenience or preference. Each electronic billboard can be individually or collectively auctioned by launching a broadcast auction for different electronic billboards.

Provision may be made on the management site for content management with the user having the ability to type text and select colors and background colors or patterns from standard images available at the web site. Bidder should have minimum content specified at the time of the bid. This may include video, animation, graphic, text or images created at the site or uploaded or attached as part of the bidding process. Minimum content advertising created with text and images from the site may be automatically scanned for undesirable, illegal, or obscene messages. Such undesirable messages can be automatically rejected for content. Messages created in this manner which pass requirements for content can be automatically approved and set for scheduling upon award or a successful bid process. This allows the system manager to manage content with some automated features to insure minimum content is acceptable with the lowest cost to the management service.

Customers may add pre-designed content including clipping images into image management sections of the managing web site. The process can include drag and drop images, or be attached as files to be uploaded. Such pre-designed content must be approved for content and must be sent to the service management system within a limited time frame. This pre-designed sort of content may be registered with a file name and be approved so that it can be used in future advertising schemes without having to with for the approval process. This sort of pre-approved format can be selected by the user much later in the time frame and closer to the actual display time. The cut-off time for this service may be limited as well according to the system manager's preference.

A winner may be notified of his winning status and notified of what content is to be used in the advertisement. The winner may be then given a limited time to add new content which may need approval, or a different limited amount of time to select pre-approved content for the advertising period. If additional content is not provided within the required time or if the additional content fails to meet requirements for decency or other reason, the content defaults to the minimum content provided at the time of the bid process. In this way the advertising space always has an ad to display and the time slice is not lost due to unspecified content.

In the case where the bid process does not require minimum content to be specified at the time of the bid process the system may default to displaying the company name or some other message so that the advertising slice will not be lost. The method for selecting a default message may be designated by a process according to the preferences of the system management. If for any reason, the winner is not able to provide on time the advertising material, the system reserves the right to contact the customer second in the auction list.

In the case where content is not purchased by the bid process or other means, the system managing the billboard or the managing company may make decisions about how to utilize the available time slices. These time slices may be offered in bulk to certain advertisers, reserved for the management's special purposes such as promoting the service, or made available for public service messages according to the wishes of the system managers.

Advertisers may bid for services on an individual billboard, or on a series of billboards in one process according to the design of the service. There may be provision for selecting multiple sites according to groups or according to an individual selection process where the customer selects the locations from locations on a map or from a list of locations. A bid may be placed for all the locations selected at one time. If a time slice for a particular location or set of locations is unavailable due to previously commitments then the system may have the feature to suggest close or adjacent time slices to be included in the bid with the approval of the bidder. In this way a purchaser might get all the locations selected at the specified time, or with approval have slightly different time slices in some locations.

Before or during the due advertising time, customers upload their advertising material (mainly pictures or messages) through the Web on their account or create the content on the services web site. The space manager thoroughly checks that the content is appropriate and schedules display at the right place and right time. If the advertising material content is not appropriate, the space manager informs the customer and permits substitution that will be displayed if appropriate. The customer can provide alternate content with the original submission, permitting the space manager to select this automatically if the first priority content is rejected.

At any time, customers can check the location and availability of advertising spaces. Customers who reserved several locations at different times, will be able to send specific contents for each location or send a broadcast ad to all locations and times. A customer, whose ad is displayed at a specific time, will be able to check the status of his order in real time. When the order is complete, an electronic ticket is sent to the customer with a status report detailing the success in the bid process, billing specifics, advertising message specifics and giving time limits for modifying content. This status report may also include information regarding system downtime or service issues or estimated level of traffic at that location if available. Additional pertinent information may also be included, such as weather conditions, traffic conditions and the like.

At any time, each customer can change the information of his/her account. The customer account includes fields of whereabouts (last name, first name, company, address, phone, email, billing information), profile (gender, industry, and job information), security (user name, password and payment information), advertising material inventory and advertising schedule. Upon completion of an advertising job, an electronic ticket will be sent to customers providing the amount due. Administrators, authorized individuals, or company accounts with a proper password can log into the system at any time to determine status of advertising and status of their accounts.

When a bidder is the lead bidder in a bid process the system may notify the bidder of his leading status. If that status changes the system may send an automated message to the bidder to inform the user that some other bidder has taken the lead in the bid process. In this way a bidder has an opportunity to increase the bid and resume the winning position in the process.

E-auctions optimize advertising revenue, eliminate the needs for sales force and provide direct monitoring of the market. Advertising time widens the customer bases. The electronic billboard advertising service will enable the rent of advertising space and time.

In summary, the subject invention utilizes a remotely controlled electronic billboard to provide dynamic advertising which can be scheduled within specific time periods to maximize exposure to targeted consumers. The time and space on the billboard is made available in an open auction, permitting the highest bidder for each time slot to utilize the billboard. Where desired, guaranteed pricing may be utilized to lock in space and time to those advertisers willing to pay a higher price. The present invention supports e-commerce transactions directed to placement of advertising on dynamic signs by creating dynamic e-commerce Web sites for permitting consumers to select and acquire time and space on selective signs, for managing the content of a consumer message and for collecting payment for the acquired time and space. The content may be provided by the consumer by uploading it to the Web sites or by the manager of the Web site. Space and time may be auctioned over the Web sites, allowing consumers to competitively bid for specific space and time blocks. Billing may be by approved account, electronic billing and payment, Internet payment system or other method. Unused space can continue to be auctioned using the system or commercially available sellers such as E-Bay or the like.

While one embodiment of the invention contemplates a system of signs owned by an operator who controls the signs from a remote, central location, it should be understood that the management system would lend itself equally well to managing signs owned by any number of operators, with the system operator acting as a fleet manager.

The invention and its features will be more readily understood by reference to the attached drawings and following detailed description of the preferred embodiments.

### BRIEF DESCRIPTION OF THE DRAWINGS

FIG. 1 is an overview of the system process.

FIG. 2 is a flow chart of the bid, purchase and set-up for a typical advertising display.

FIG. 3 illustrates the flow chart for completion of the deployment and display of the accepted ad and communication with the accepted customer.

FIG. 4 illustrates the flow chart of FIG. 3 modified to included an emergency preempt display.

### DETAILED DESCRIPTION OF THE PREFERRED EMBODIMENT

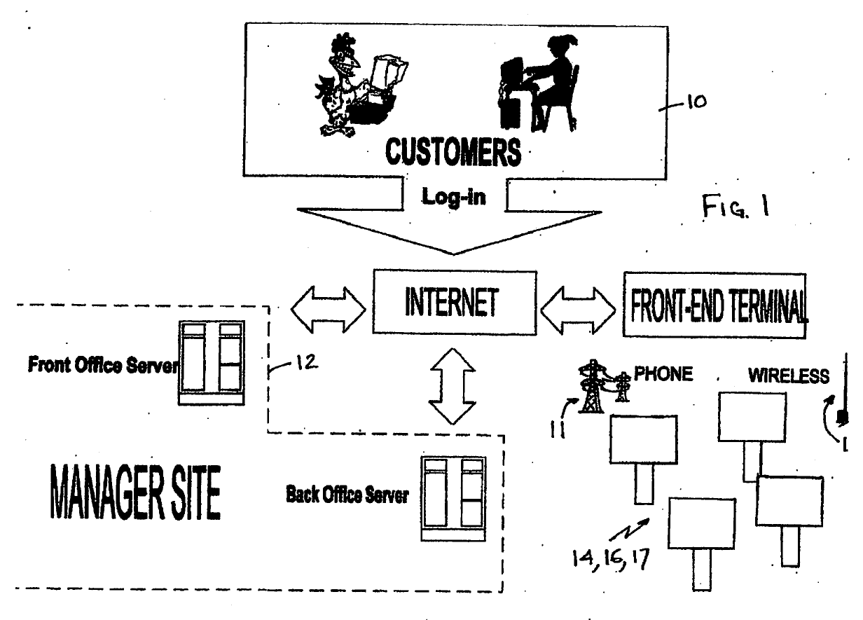

An overview of the system is shown in FIG. 1. One or more customers 10 will log-in to the system website 12. The site 12 can be accessed from anywhere on the Internet, for example from an office terminal by the employee of a company or from a home, school, agency or other site. Once logged in, the customer 10 will provide verification and billing information. Once accepted, the customer will be directed to various functions and services on the website, including the location and space times available on various billboards. Typically, the verification information will provide criteria for identifying which billboard locations are of interest to the customer and these will be displayed to him.

Once the customer has selected one or more locations and times, he then places an order. This is done by selecting either the guarantee price, which assures him of the space and time he has selected, or by starting the bid process to participate in an on-line auction for the space. Once the on-line auction is initiated, he can check in real-time to determine the status of his bid. He can modify his bid at any time during the open period. He can bid only one space and time or multiple spaces and times. Once a bid is accepted, the winning bidder will supply proposed content, which is anything he desires to display on the selected signs. Where desired, the bidder may be required to provide the proposed content with his initial bid and acceptance of the bid may contingent upon the submission of acceptable content.

At a set time prior to the time when the space/time slot(s) are to be utilized, the bidding will be closed. Typically, this will be a minimum of 48 hours. However, the time is at the option of the site manager. The winning bidder is then notified and is requested to send his ad copy to the website 12 via the Internet. The ad copy is then reviewed for content. If approved, the winning bidder is notified and his ad is sent to the selected display location(s) 14, 16 at the selected time(s) via the Internet to be displayed on the billboard(s). Winners will be notified when the auction is closed. It may be desirable to also notify losers, or the losers could be informed that if they have not been notified by a specified time they did not win the bid.

In the event the content is not approved, the winning bidder will have a fixed time to revise the ad content. If this is accomplished, then the ad is sent to the selected display location(s) and time(s) as previously approved. The advertising content is at the discretion of the winning bidder, providing specific quality and content criteria are met. This includes changing the content of the ad at any time, again within predefined constraints.

In the event the content is not timely corrected, the system will either (1) defer to the next highest bidder or (2) recover the space/time slots and place them back into the inventory pool.

The site will have available a complete inventory of available space, including a map of locations, available time and space on each sign in the inventory and other pertinent information. This will permit prospective bidders to make informed decisions as to how to participate in the bidding process. It will also permit winning bidders to preview and monitor the space, content, time and location they have purchased. Typically, a log will be maintained for both historical and auditing purposes.

In its preferred configuration, the Internet is the communication system of choice. However, it should be understood that the system will also accommodate other communication systems. For example, the bidding process could be by text messaging over cellular systems. The communications systems between the system website 10 and the display locations 14, 16, could also be via cable, telephone line or wireless systems such as cellular phone, satellite or radio.

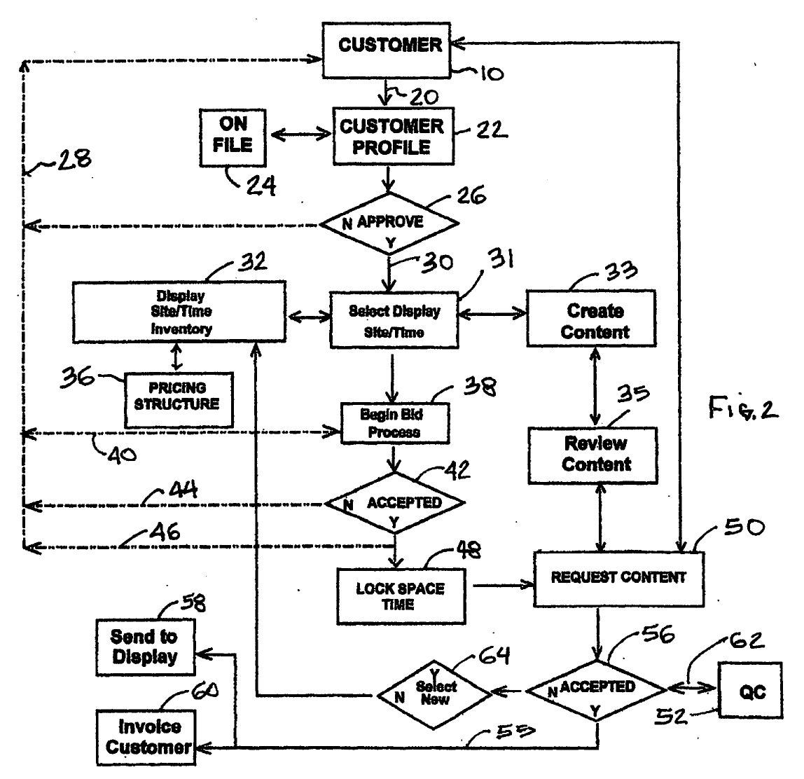

A flow chart of the system process is shown in FIG. 2. Initially, a customer 10 will log-in to the website as indicated at 20. At this time he will be asked to provide his profile 22. If a repeat customer is on file in the system data base as indicated at 24, he merely needs to enter his password to access the profile information. If new, or not on file he will be asked to identify himself, his company or entity if applicable, location information including those locations he is interested in for placing ads, billing information and other relevant data.

He is then reviewed for approval at 26. If not approved, additional information is requested and the process is repeated as indicated at 28 and the process is repeated. Once approved, as indicated at 30, the customer then selects the display site and display time 30 from the display inventory 32. The available sites and times, based on the customer profile, are communicated to the customer as indicated at 34. Once selected, the pricing structure 36 for the specific site and time is communicated to the customer as indicated at 34. Typically, the pricing structure will include a floor or minimum price acceptable for the selected space and time. It may also include a guarantee price which, if met by the consumer, will close the bidding and assure the customer of the space and time selected.

In most cases, the customer will begin the bid process 38 by placing his initial bid. The status of his bid will be communicated to him as indicated at 40. He can continue to update his bid until the bidding is closes. The system may be programmed to notify a bidder each time his bid drops below the winning bid price.

The final bids will be tallied as indicated at 42 and any customer who is not the high bidder will be notified as indicated at 44. The winning customer will be notified as indicated 46 and the selected space/time block will be locked 48. At this point, the system will request the ad content or perhaps additional or optional ad content from the customer as indicated at 50. Content may be pre-approved or may be automatically validated if created using an on-site editing feature. The content is then reviewed 52 for quality control purposes and passed for acceptance or rejected at 56. If the content is acceptable 55 it is forwarded to the display at the appropriate time, as indicated at 58. The customer is invoiced for the ad as indicated at 60. As shown at 33, the content may be created at anytime during the process from any point beginning with immediately after log-in at 20 or at the point where the content is requested, as at request step 50.

Creation of the content can be by several methods. For example, inventoried content may be used. Preliminary or minimum content may be entered for pre-approval and late updated. At the point when content is created it may be reviewed, by the manager, as shown at 35. This will expedite the process if the customer is the accepted customer. Therefore, the advantage to entering content early is that it expedites the process. The advantage to withholding content until after the customer is accepted at 42 is that the customer is not required to go to the expense of creating content until he is assured of acceptance of his bid.

During the creation and review process, the content may be viewed by the customer or the system, it may be edited and it may be inventoried for repeated use. The system web site will accept uploaded files, including a drag-and-drop capability. Whenever the content is loaded as indicated at 33, it will under automatic review and the customer will be notified of acceptability, as indicated at 35. This will be preliminary to the final quality review indicated at 52 and 56.

In the event the ad content is not acceptable the customer is so notified as indicated 62 and he will have a specified time period to correct the content. Once this is accomplished, the system returns to the acceptance loop 55. If the content is not rendered acceptable within the specified period, the system will select the next highest bidder as indicated at 64. The newly selected customer will then be requested to send ad copy as indicated at 50 and the process for acceptance at 56 will begin anew. Ad content which is specified but not acceptable may trigger reversion of advertisement to minimum content advertisement created on site or even company name according to system management's default configuration.

At the option of the system manager, once content is finally rejected the locked space/time block is indicated at 66.

The customer may bid on a single space/time block or multiple space/time blocks at his discretion. In addition, the ad copy may be for a single space/time block or for multiple space/time blocks. The customer controls the ad content with the exception that it is reviewed for quality control and can be rejected if it does not meet the requirements of the site manager.

One important aspect of the invention is that the customer is not charged for participating in the bid process unless he wins the bid and then only after his ad content is accepted. This encourages broad participation because there are not any upfront fees. The actual auction process can be in accordance with any of the well known on-line auction systems. The invoicing and payment system can be by credit card, client account or other cash transfer system. The invention is not limited to any specific form of invoicing and payment.

At any time, customers and potential customers can check the location and availability of advertising spaces without committing to entering the bid process. Customers who reserved several locations at different times, will be able to send specific contents for each location or send a broadcast ad to all locations and times. Historical data and other logged information may be reviewed in this manner, as well.

At any time, each customer can change the information of his/her account. The customer account includes fields of whereabouts (last name, first name, company, address, phone, email), profile (gender, industry, job information), security (user name, password and payment information), advertising material inventory and advertising schedule. Upon completion of an advertising job, an electronic ticket or hard invoice will be sent to customers providing the amount due. It is also possible to set up an account which will be billed directly upon completion of the job.

A customer, whose ad is displayed at a specific time, will be able to check the status of his order in real time. When the order is complete, an electronic ticket is sent to the customer with a quality report detailing any downtime and the estimated level of traffic at that time.

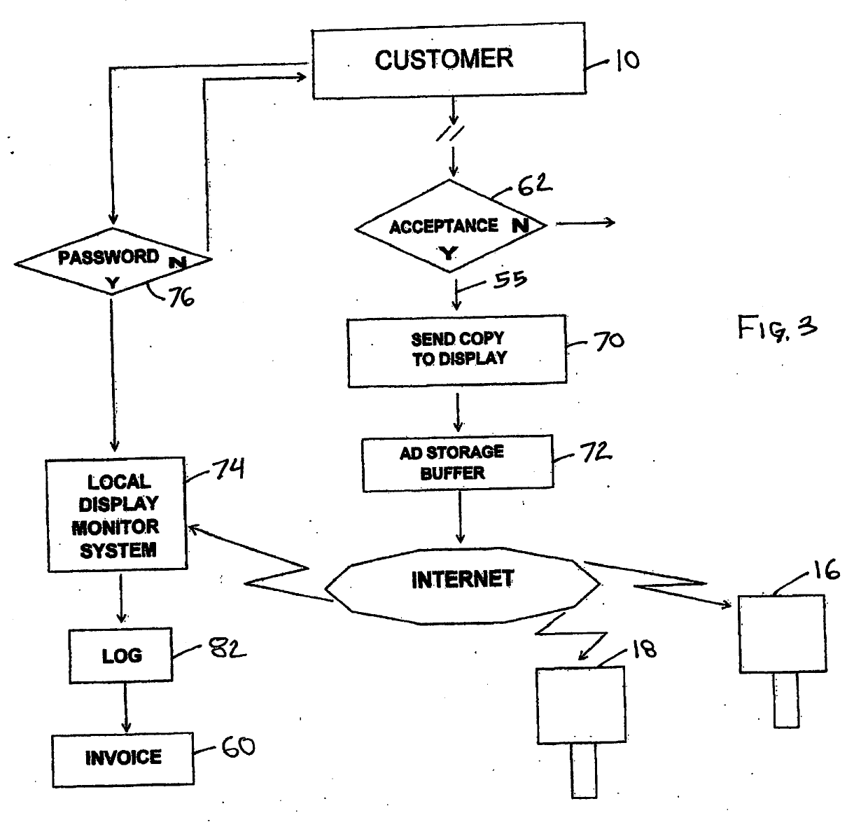

FIG. 3 illustrates the flow chart for completion of the deployment and display of the accepted ad and communication with the accepted customer and is an expansion of the acceptance loop 55 of FIG. 2. Once the ad is accepted it is sent to an ad storage buffer (or database) 70. At the selected time the ad is sent via a communications network to the selected locations 14, 16 and displayed. The location devices 14, 16 send the display back via the communications network to a site based display monitor system 74 to assure that the ad is in fact displayed. The customer 10 will have real time, password encoded access 76 to the site display advertisement management system 74 so that he can assure that the ads are being displayed.

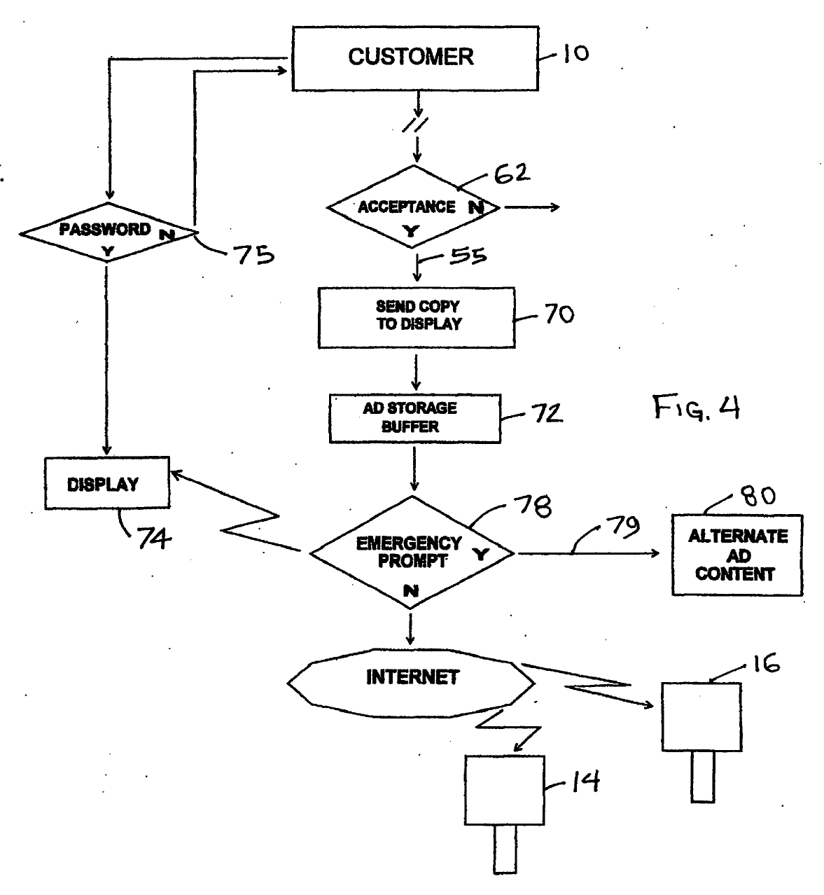

An additional important feature of the system of the present invention is the ability to permit selected government agencies to use the billboard for public information during certain types of emergencies such as, by way of example, Amber Alerts, flooding, hurricane evacuation information, accidents and the like. As shown in FIG. 4, the system has an interrupt feature in the acceptance loop to accommodate this type of action. When this feature is available, the system will check for an emergency preempt at 78 before sending the ad copy from the buffer 72 to the selected display locations 14, 16. If no preempt is present, the system operates as explained with reference to FIG. 3. If an authorized preempt is present as indicated at 79, then the scheduled add is preempted and alternate, authorized ad copy 80 dealing with the emergency is transmitted via the communication system to the selected locations 14, 16. It should be understood that the selected locations can be any or all of the available sites, depending upon the nature of the emergency.

A preset price may be established for such public service or emergency service messages and this price may have special billing arrangements, including possible reductions in rates and may include some provision for tax credits in exchange for the service or for reduced prices for the service.

As indicated in FIG. 3, the actual display time is logged at 82. The customer is then invoiced for the actual display time rather than the purchased display time if there is a discrepancy. For example, if the system is down for any reason, the customer will not be charged for down time. In addition, emergency interrupts will be credited to the customer account. This is far superior to current systems because the uptime and downtime can be monitored from any location having access to the communication network used, as opposed to the requirement of having to physically travel to and check a static sign or even most prior art electronic signs.

The overall management functions permitted by the site display advertisement management system of the present invention permits maximum flexibility in the selection of advertising time and space by the advertiser and optimizes efficiency, revenue and management for the operator. The system can be used for closed advertising such, by way of example, a strip mall with dynamic signage to be used by tenants, or open advertising for all advertisers, such as billboards in public view.

The method of the subject invention supports notifying the winning customer when space is auctioned, whether or not the auction is a closed auction as in the case of the strip mall or an open auction as in the case of a billboard on a highway or the like. It may also be desirable to notify the losing customer, and notify him of his status, particularly if he is next in line if the winning customer is disqualified for any reason.

In management of the system, the winning customer typically is requested to provide acceptable ad content within a specified time period sufficient to permit adequate quality control of content. The winning bidder is notified that his content is approved for a location including any or all of video, animation, transitional messages, and fixed stable messages.

The winning customer's space and time will be canceled if the acceptable ad content is not received within the specified time period. In the event the winning customer is finally disqualified, the next-in-line customer is notified of his acceptance and is given a specified time in which to respond and provide acceptable ad content.

The system also supports permitting the winning bidder to edit, modify or enhance their advertising content if initially rejected. The advertising content may also be modified after submission, including modification of displays once transmitted, provided the same quality control conditions are met.

If no acceptable advertising content is received from any bidder who is notified of success, the space and time is returned to inventory.

An important feature of the invention is the provision for access by public agency to place agency controlled content on the billboard. In one embodiment, the public agency can preempt previously scheduled and displayed ad content during an emergency. In this event, the system logs the preemption time and credits the advertiser for the time lost.

The advertising space available in accordance with the subject invention supports subdividing billboards for special applications, including a company logo or icon as a stable portion of the display along with the advertisement of other advertisers. For example, a soft drink company may have a permanent display along with dynamically changing advertisements of others. It may be desirable to reserve sections of a billboard for special action such as logo or icon display, thus potentially maximizing revenue for the billboard, while still permitting extensive dynamic advertising.

The space may be subdivided for both on-premise and off-premise advertisers in order that multiple advertisers may share according to ad space rather than by ad time or in addition to ad time. In such a case it may be desirable to include borders around sections of subdivided billboard space. The space may also be subdivided into specific time slots on specific days.

The advertising content may be dynamic, including moving background space in content, changing colors, streaming video, animation, streaming data, moving graphics, floating or moving text and other dynamic features. As an example, the streaming data might include stock quotes, weather conditions, traffic conditions and the like.

While the invention contemplates a fully integrated site including on site management of sales and auctions of space, it should be understood that the invention fully supports use of commercially available sales tools such as on-line sales and auctions using such providers as “Ebay” or similar sites. Revenue sharing models may be created, whereby revenue may be shared with owners of properties whose advertising is included within the pool of resources. The system supports automatic billing processes including all e-commerce methods, such as direct debit, credit card payment, and “Pay Pal” type services where a company has an account which is automatically debited for service. In addition, direct billing accounts may be established for approved customers.

In the event one of more of his selected time slots are already locked by some winning price, the bidder can be notified of additional available locations and time slots, including confirming the availability of additional time slots if the bidder is interested.

A bidder may bid on multiple ad locations in a single bidding process, and may even establish a priority so that he only has to purchase the highest available priority in the event of multiple successful bids.

The system supports group advertising selection using map or list of available locations, including permitting a bidder to create his own list for group selection. In the preferred embodiment of the invention alternative advertising locations or time slots in a group advertising bid process are presented to the bidder.

If desired, the system manager can manage target prices based on historical winning bid rates. The system manager can also allocate unscheduled advertising time allocation. The logging capability of the system collects data related to advertising revenues for purposes of accounting or modification of base advertisement rates. The data is also useful for purposes of promoting investment by others in resource pool assets.

A specialized billing process may be adapted for public service announcements and emergency messages, which may give price reductions in exchange for tax credits which may be available, further increasing the positive revenue performance of the space.

The system supports all heterogeneous media, including but not limited to billboards, television screens, and electronic papers.

The dynamic advertising system of the present invention provides a remotely controlled electronic billboard for supporting dynamic advertising which can be scheduled within specific time periods to maximize exposure to targeted consumers. The time and space on the billboard is made available in an open auction, permitting the highest bidder for each time slot to utilize the billboard. The customer has real time, remote access to the site display advertisement management system to confirm its presence on selected sites at selected times.

While certain embodiments and features have been described in detail herein, it should be understood that the invention includes all modifications and enhancements within the scope and spirit of the appended claims.

What is claimed is:

1. A dynamic visual advertising system comprising:
a. at least one electronic billboard for displaying a visual ad;
b. a management site remote from the billboard;
c. a communications network associated with the management site and the billboard for supporting communications between the management site and the billboard; and
d. a third party access point to the management site, the third party access point permitting the third party to select time and space on the billboard.

2. The advertising system of claim 1, including a plurality of billboards, wherein the third party may select time and space on any of the plurality of billboards based on any one or more of the following criteria: capabilities, location, size of display, and grouping of billboards.

3. The advertising system of claim 1, wherein the communications network is the Internet.

4. The advertising system of claim 1, wherein the communications network is a cellular network.

5. The advertising system of claim 1, wherein the communications network is a telephone line.

6. The advertising system of claim 1, wherein the communications network is a satellite communications system.

7. The advertising system of claim 1, the third party access point comprising a website accessible over the Internet by the third party.

8. The advertising system of claim 1, wherein the third party can provide ad content for the visual ad on the electronic billboard via the access point.

9. The advertising system of claim 1, further including public agency access to the system via a controlled access point.

10. The advertising system of claim 8, further including public agency permission to preempt a visual ad on the electronic billboard with a public message.

11. The advertising system of claim 8, wherein the ad content provided by the third party is directed to the management site and the management site can accept or reject the ad content with rejected ad content.

12. The advertising system of claim 11, wherein the third party can create content on the management site from a standard selection inventory.

13. The advertising system of claim 12, wherein the standard selection inventory includes text content.

14. The advertising system of claim 12, wherein the standard selection inventory includes font selection.

15. The advertising system of claim 12, wherein the standard selection inventory includes graphics.

16. The advertising system of claim 12, wherein the standard selection inventory includes images.

17. The advertising system of claim 12, wherein the standard selection includes video.

18. The advertising system of claim 12, wherein the standard selection includes animation.

19. The advertising system of claim 1, the third party can review on the management site the content of the advertisement to be placed therein.

20. The advertising system of claim 1, wherein the billboards are dynamic and can include moving scenes as well as stationary copy.

21. The advertising system of claim 20, wherein the moving scenes includes preprogrammed video.

22. The advertising system of claim 20, wherein the moving scenes include live video.

23. The advertising system of claim 1, wherein the advertising content may include borders between ads of different sources.

24. The advertising system of claim 23, wherein said borders are dynamic.

25. The advertising system of claim 8, further including a management system for scheduling the placement of client ad content on the billboard.

26. The system of claim 8, wherein the management system schedules the time and day for placement of the ad content on the billboard.

27. The system of claim 1, the third party access point further including a pricing scheme whereby the third party can select the price he desires to pay for the ad based on location and time of display on the billboard.

28. The system of claim 27, wherein the pricing scheme comprises an on-line auction in which the third party participates.

29. The system of claim 28, wherein the third party is notified if he is the winning bidder and wherein he then submits his ad content for display on the billboard at the selected time.

30. The system of claim 29, wherein the third party is notified if he is the losing party.
